(19) United States
(12) Patent Application Publication
(10) Pub. No.: US 2021/0087664 A1
(43) Pub. Date: Mar. 25, 2021

(54) HEAT-TREATABLE ALUMINUM ALLOY MADE FROM USED BEVERAGE CAN SCRAP

(71) Applicant: Apple Inc., Cupertino, CA (US)

(72) Inventors: Eric W. Hamann, Santa Clara, CA (US); Weiming Huang, State College, PA (US); Brian M. Gable, San Jose, CA (US); Herng-Jeng Jou, San Jose, CA (US); William A. Counts, Sunnyvale, CA (US)

(21) Appl. No.: 17/020,346

(22) Filed: Sep. 14, 2020

Related U.S. Application Data
(60) Provisional application No. 62/949,048, filed on Dec. 17, 2019.
(60) Provisional application No. 62/905,819, filed on Sep. 25, 2019.

(51) Int. Cl. C22F 1/047; B32B 15/01; C22C 21/08

(52) U.S. Cl. CPC C22F 1/047; C22C 21/08; B32B 15/016

(57) ABSTRACT

An aluminum alloy that may include 0.45 to 0.85 wt % Si, 0.15 to 0.25 wt % Cu, 0.40 to 0.80 wt % Fe, 1.20 to 1.65 wt % Mg, and 0.80 to 1.10 wt % Mn, where the balance is aluminum and incidental impurities. The alloy can include used beverage can (UBC) scrap.

### CROSS-REFERENCES TO RELATED PATENT APPLICATIONS

This patent application claims the benefit under 35 U.S.C. § 119(e) of U.S. Patent Application Ser. No. 62/905,819, entitled “HEAT-TREATABLE ALUMINUM ALLOY MADE FROM USED BEVERAGE CAN SCRAP,” filed on Sep. 25, 2019, and claims the benefit under 35 U.S.C. § 119(e) of U.S. Patent Application Ser. No. 62/949,048, entitled “HEAT-TREATABLE ALUMINUM ALLOY MADE FROM USED BEVERAGE CAN SCRAP,” filed on Dec. 17, 2019, each of which is incorporated herein by reference in its entirety.

### FIELD

The disclosure is directed to aluminum alloys that can incorporate used beverage can scrap. The disclosure also relates to a clad including a recycled aluminum substrate and a surface layer.

### BACKGROUND

Aluminum can contribute to a part of carbon footprint. One of the most effective methods of reducing the carbon footprint and aluminum mining is by increasing the use of recycled aluminum, especially post-consumer recycled (PCR) aluminum. One of the major sources of PCR aluminum is used beverage can (UBC) scrap. Increased recycling can have a large impact on reducing the carbon footprint and primary aluminum consumption.

There still remains a need for developing techniques for recycling UBC scrap into heat-treatable aluminum alloy.

### BRIEF SUMMARY

In an embodiment, an aluminum alloy may include 0.45 to 0.85 wt % Si, 0.15 to 0.40 wt % Cu, 0.40 to 0.80 wt % Fe, 1.20 to 1.65 wt % Mg, and 0.8 to 1.10 wt % Mn, wherein the balance is aluminum and incidental impurities.

In an embodiment, a clad may include a substrate formed of the aluminum alloy. The clad may include a first surface layer disposed on a first surface of the substrate, the surface layer formed of an aluminum alloy having a different chemical composition than the substrate.

In an embodiment, a method of fabricating a product from the clad is provided. The method may include hot rolling the first surface layer and the substrate of the clad to form a clad. The method may also include cold rolling the clad to form a rolled clad. The method may also include solution heat treating the rolled clad to form a rolled clad. The method may also include forming a product from the rolled clad.

Additional embodiments and features are set forth in part in the description that follows, and will become apparent to those skilled in the art upon examination of the specification or may be learned by the practice of the disclosed subject matter. A further understanding of the nature and advantages of the disclosure may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1A illustrates a clad configuration in accordance with a first embodiment of the disclosure;

FIG. 1B illustrates a clad configuration in accordance with a second embodiment of the disclosure;

FIG. 2A illustrates hot rolling to form a clad in an embodiment of the disclosure;

FIG. 2B illustrates an optical image of the cross-section of FIG. 2A in an embodiment of the disclosure;

FIG. 2C illustrates a coil formed of the clad of FIG. 2A in an embodiment of the disclosure;

FIG. 3 illustrates a flow chart including steps for fabricating a product from recycled UBC scrap in an embodiment of the disclosure;

FIG. 4 illustrates estimated yield strengths versus silicon (Si) composition of a custom aluminum alloy in an embodiment of the disclosure;

FIG. 5 illustrates estimated maximum allowable processing temperature versus silicon (Si) composition of a custom aluminum alloy in an embodiment of the disclosure;

FIG. 6 illustrates estimated thermal conductivities versus silicon (Si) composition of a custom aluminum alloy in an embodiment of the disclosure;

FIG. 7 illustrates measured yield strengths of custom aluminum alloys in an embodiment of the disclosure; and

FIG. 8 illustrates measured tensile strengths of custom aluminum alloys in an embodiment of the disclosure.

### DETAILED DESCRIPTION

The disclosure may be understood by reference to the following detailed description, taken in conjunction with the drawings as described below. It is noted that, for purposes of illustrative clarity, certain elements in various drawings may not be drawn to scale.

Clad

It is very difficult to make a cosmetic aluminum alloy from recycled material, such as UBC scrap. However, it is possible to clad a surface layer and a substrate, such as a substrate formed from a recycled material such as UBC scrap. The surface layer can have various properties that provide cosmetic appeal. The substrate can include previously used aluminum, such as UBC scrap, that can increase the total amount of aluminum recycling. The clad can be designed such that a property or properties of the substrate are within a range of properties of the surface layer.

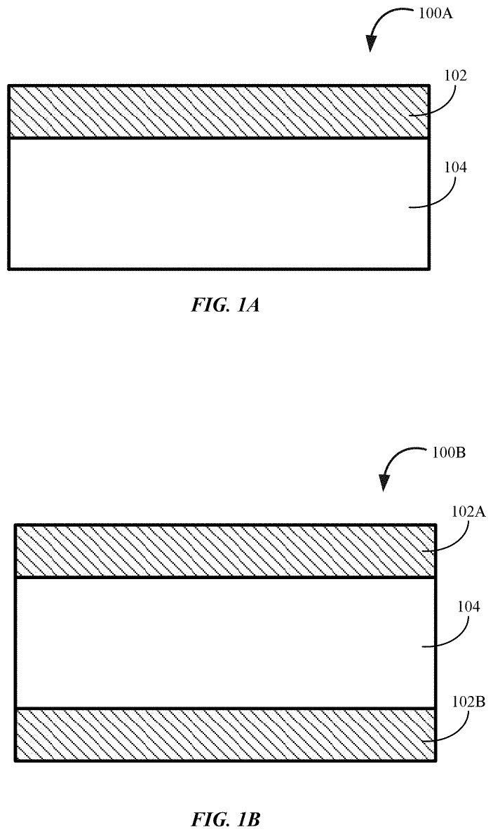

A custom alloy can be designed to incorporate high levels of UBC scrap. The custom alloy can also be designed to be compatible with conventional cladding processes and to be compatible with cosmetic alloys for the surface layer(s) in a clad configuration. FIG. 1A illustrates a clad configuration in accordance with a first embodiment of the disclosure. As shown, a clad 100A may include a surface layer 102 over a substrate 104, such as a substrate formed from recycled aluminum including UBC scrap or an alloy or a custom alloy incorporating UBC scrap.

FIG. 1B illustrates a clad configuration in accordance with a second embodiment of the disclosure. As shown, a clad 100B may include a substrate 104 between a top surface layer 102A and a bottom surface layer 102B. The substrate between two surface layers can also be referred to as a core. The substrate 104 can be formed from the recycled material (e.g., including UBC scrap), or the custom alloy incorporating recycled material.

The clad provides an alloy that has both cosmetic appeal and durability. Also, implementing a cosmetic and durable surface layer can allow the use of non-cosmetic substrates, such as recycled materials. This is different from traditional clad layers, in which the surface layers are often formed of pure aluminum. These pure aluminum alloys, while being potentially cosmetic, are soft and lack durability. The surface layer(s) can have cosmetic or other properties not available in recycled materials. For example, the surface layer(s) may have a hardness, thermal conductivity, or corrosion resistance different from the substrate or core, among others. In some embodiments, the surface layer may have higher or lower hardness, higher or lower thermal conductivity, better corrosion resistance than the substrate or core.

In some variations, the surface layer may include a 2000 series aluminum alloy (e.g. 2024 alloy), a 6000 series aluminum alloy (e.g. 6063, 6061, 6111, or 6022 alloys), or a 7000 series aluminum alloy (e.g. 7050 or 7075 alloys), which are all heat-treatable.

In some variations, the surface layer can be a cosmetic layer. The surface layer may include a 6000 series or 6xxx aluminum alloy having 0.35 to 0.80 wt % Si, 0.45-0.95 wt % Mg, 0.10-0.50 wt % Fe, 0.005-0.09 wt % Mn, and 0.01-0.05 wt % Cu, with the balance being aluminum and incidental impurities. A recycled aluminum alloy including up to 100% manufacturing scrap was disclosed in U.S. Patent Application No. 62/716,606 (attorney docket No. P37073USP1), entitled “Recycled Aluminum Alloys from Manufacturing scrap with Cosmetic Appeal,” filed on Aug. 9, 2018, which is incorporated by reference in its entirety.

In some variations, the substrate is a non-cosmetically appealing material derived from recycled material, such as UBC scrap. The recycled material may have Cu greater than 0.15 wt % and Fe greater than 0.4 wt %. In some variations, the recycled aluminum alloys can be reinforced with ceramic particulates (e.g. metal matrix composites), etc.

In some variations, the recycled material is a heat-treatable custom alloy that incorporates used beverage can (UBC) scraps and adds other alloying compositions. The UBCs were formed of a non-heat-treatable 3000 and 5000 series aluminum (e.g. 3104 and 5182 alloys).

The clad can be tested for cosmetics, stamped profile performance, consistency, and corrosion resistance among others.

In some variations, the clad formed from the cosmetic and durable surface layer and the recycled material can be used to make consumer electronic applications. It will be appreciated by those skilled in the art that the clad may be used for other applications.

Custom Alloys Used for Substrate Materials

An alloy can be customized to incorporate UBC scrap and have similar properties to a surface alloy, even though the custom alloy is not cosmetically appealing. The resulting custom alloy has similar properties to the aluminum alloy used on the surface layer.

In some variations, the custom alloy can be designed to incorporate recycled aluminum (e.g., UBC scrap) in order to be used in a clad configuration. There are several aspects that can assist in selection of the custom alloy to incorporate UCB scrap for clad applications. In some variations, the custom alloy is compatible with one or more production processes for the surface layer, including hot rolling, solution heat treatment, and forming (e.g. stamping), among others. In some variations, the custom alloy can be age-hardenable. In some variations, the custom alloy can have the properties matched to the alloy of the surface layer. In some variations, the custom alloy can use a significant portion of the available UCB scrap on the market.

To design the custom alloy, UBC scrap composition data were collected. Properties of the alloys can be determined either by measurement or a computational tool (e.g., Thermocalc). The alloy composition for the custom alloy can be adjusted such that the alloy can have one or more properties similar to or within a range of the surface layer, such as a mechanical strength that matches with that of the surface layer. The alloy composition can also be selected to prevent incipient melting at clad processing temperatures. The alloy composition can further be selected to have higher thermal conductivity and higher corrosion resistance, than in unmodified recycled scrap. These properties can include mechanical properties, melting temperature, recrystallization temperature, thermal conductivity, and corrosion resistance, among others, can be matched to the surface layer.

Based on the simulation analysis, the custom alloy was designed to allow a higher quantity of alloying elements than commercial heat-treatable alloys and would allow incorporation of UBC scrap of at least 90% or more. When the alloy composition range becomes narrower, the alloy may have more consistent batch-to-batch properties.

The custom alloy was designed to allow very high levels of Mg, Fe, and Mn, which are typically found at lower levels in other heat-treatable alloys, while having one or more properties that are unexpectedly similar to the properties of an alloy that can be used as a cosmetic layer.

In some variations, the custom alloy may incorporate up to 100% UBC scrap. In some variations, the clad may include 10% cosmetic layer at 0% UBC and 90% substrate at 100% UBC.

The custom alloy is a heat-treatable alloy. The custom alloy includes Mg and Si for heat-treatable hardening, but allows high levels of Cu, Fe, and Mn as alloying elements. Some commercial alloys may have overlapping compositions, such as 5140 aluminum alloy. The 5140 aluminum alloy may include Si of 0.7 MAX, Fe of 0.6 MAX, Cu of 0.6 MAX, Mn of 0.7-1.3, Mg of 1.1-1.5, Cr: 0.1 MAX, Zn of 0.4 MAX, Ti of 0.1 MAX. However, 5140 alloy is a work-hardened, but not heat-treatable alloy.

In some variations, the custom alloy may include high levels of Mg, Cu, Fe, and Mn from recycled materials, such as UBC scrap.

The custom alloy can have a composition that has the properties corresponding to the surface layer, but developed from recycled aluminum. The aluminum alloy can include. 0.45 to 0.85 wt % Si, 0.15 to 0.40 wt % Cu, 0.40 to 0.80 wt % Fe, 1.20 to 1.65 wt % Mg, and 0.8 to 1.1 wt % Mn, with the balance being aluminum and incidental impurities. The alloy can optionally have up to 0.25 wt % Zn, up to 0.1 wt % Cr, up to 0.10 wt % Ti, up to 0.05 wt % Ca, and up to 0.05 wt % Na.

Silicon

The custom alloy may include silicon (Si) to help with strengthening the alloy. The alloy may include magnesium which can have impact on the mechanical strength, for example, by aging form a magnesium containing phase, such as Mg₂Si precipitates.

The acquisition of Si by the iron-containing particles reduces the amount of Si available for strengthening. As such, more Si is added to the custom alloys disclosed herein. The custom alloys have higher silicon and higher iron than conventional alloys. Contrary to expectations, various properties of the alloy are consistent or better than alloys with such undesirable amounts of iron.

In some variations, the custom alloy can have Si ranging from 0.45 wt % to 0.85 wt %.

In some variations, the alloy can have equal to or greater than 0.45 wt % Si. In some variations, the alloy can have equal to or greater than 0.50 wt % Si. In some variations, the alloy can have equal to or greater than 0.55 wt % Si. In some variations, the alloy can have equal to or greater than 0.60 wt % Si. In some variations, the alloy can have equal to or greater than 0.65 wt % Si. In some variations, the alloy can have equal to or greater than 0.66 wt % Si. In some variations, the alloy can have equal to or greater than 0.67 wt % Si. In some variations, the alloy can have equal to or greater than 0.68 wt % Si. In some variations, the alloy can have equal to or greater than 0.69 wt % Si. In some variations, the alloy can have equal to or greater than 0.70 wt % Si. In some variations, the alloy can have equal to or greater than 0.71 wt % Si. In some variations, the alloy can have equal to or greater than 0.72 wt % Si. In some variations, the alloy can have equal to or greater than 0.73 wt % Si. In some variations, the alloy can have equal to or greater than 0.74 wt % Si. In some variations, the alloy can have equal to or greater than 0.75 wt % Si. In some variations, the alloy can have equal to or greater than 0.76 wt % Si. In some variations, the alloy can have equal to or greater than 0.77 wt % Si. In some variations, the alloy can have equal to or greater than 0.78 wt % Si. In some variations, the alloy can have equal to or greater than 0.79 wt % Si. In some variations, the alloy can have equal to or greater than 0.80 wt % Si.

In some variations, the alloy can have equal to or less than 0.50 wt % Si. In some variations, the alloy can have equal to or less than 0.55 wt % Si. In some variations, the alloy can have equal to or less than 0.60 wt % Si. In some variations, the alloy can have equal to or less than 0.66 wt % Si. In some variations, the alloy can have equal to or less than 0.67 wt % Si. In some variations, the alloy can have equal to or less than 0.68 wt % Si. In some variations, the alloy can have equal to or less than 0.69 wt % Si. In some variations, the alloy can have equal to or less than 0.70 wt % Si. In some variations, the alloy can have equal to or less than 0.71 wt % Si. In some variations, the alloy can have equal to or less than 0.72 wt % Si. In some variations, the alloy can have equal to or less than 0.73 wt % Si. In some variations, the alloy can have equal to or less than 0.74 wt % Si. In some variations, the alloy can have equal to or less than 0.75 wt % Si. In some variations, the alloy can have equal to or less than 0.76 wt % Si. In some variations, the alloy can have equal to or less than 0.77 wt % Si. In some variations, the alloy can have equal to or less than 0.78 wt % Si. In some variations, the alloy can have equal to or less than 0.79 wt % Si. In some variations, the alloy can have equal to or less than 0.80 wt % Si. In some variations, the alloy can have equal to or less than 0.85 wt % Si.

Magnesium

The custom alloy may include magnesium, which can have an impact on the mechanical strength, for example, by aging to form a magnesium containing phase, such as Mg₂Si precipitates. UBC scrap includes more Mg than the conventional 6000 series aluminum alloys. Mg can be designed to have a particular Mg/Si ratio to form Mg—Si precipitates for strengthening purpose. In some variations, the ratio of Mg to Si is 2:1, but other variations can be possible.

In some variations, the custom alloy can have Mg ranging from 1.20 wt % to 1.65 wt %.

In some variations, the alloy can have equal to or greater than 1.20 wt % Mg. In some variations, the alloy can have equal to or greater than 1.25 wt % Mg. In some variations, the alloy can have equal to or greater than 1.30 wt % Mg. In some variations, the alloy can have equal to or greater than 1.35 wt % Mg. In some variations, the alloy can have equal to or greater than 1.40 wt % Mg. In some variations, the alloy can have equal to or greater than 1.45 wt % Mg. In some variations, the alloy can have equal to or greater than 1.49 wt % Mg. In some variations, the alloy can have equal to or greater than 1.50 wt % Mg. In some variations, the alloy can have equal to or greater than 1.51 wt % Mg. In some variations, the alloy can have equal to or greater than 1.52 wt % Mg. In some variations, the alloy can have equal to or greater than 1.53 wt % Mg. In some variations, the alloy can have equal to or greater than 1.54 wt % Mg. In some variations, the alloy can have equal to or greater than 1.55 wt % Mg. In some variations, the alloy can have equal to or greater than 1.60 wt % Mg.

In some variations, the alloy can have equal to or less than 1.65 wt % Mg. In some variations, the alloy can have equal to or less than 1.60 wt % Mg. In some variations, the alloy can have equal to or less than 1.55 wt % Mg. In some variations, the alloy can have equal to or less than 1.54 wt % Mg. In some variations, the alloy can have equal to or less than 1.53 wt % Mg. In some variations, the alloy can have equal to or less than 1.52 wt % Mg. In some variations, the alloy can have equal to or less than 1.51 wt % Mg. In some variations, the alloy can have equal to or less than 1.50 wt % Mg. In some variations, the alloy can have equal to or less than 1.45 wt % Mg. In some variations, the alloy can have equal to or less than 1.40 wt % Mg. In some variations, the alloy can have equal to or less than 1.35 wt % Mg. In some variations, the alloy can have equal to or less than 1.30 wt % Mg. In some variations, the alloy can have equal to or less than 1.25 wt % Mg.

Iron

As described above, the UBC scrap includes more Fe than the conventional 6000 series aluminum alloys. The large amounts of Fe in the custom alloy would consume Si to form coarse particles AlFeSi or AlFeMnSi.

In some variations, the custom alloy can have Fe ranging from 0.40 wt % to 0.8 wt %.

In some variations, the alloy can have equal to or greater than 0.40 wt % Fe. In some variations, the alloy can have equal to or greater than 0.42 wt % Fe. In some variations, the alloy can have equal to or greater than 0.44 wt % Fe. In some variations, the alloy can have equal to or greater than 0.46 wt % Fe. In some variations, the alloy can have equal to or greater than 0.48 wt % Fe. In some variations, the alloy can have equal to or greater than 0.50 wt % Fe. In some variations, the alloy can have equal to or greater than 0.55 wt % Fe. In some variations, the alloy can have equal to or greater than 0.60 wt % Fe. In some variations, the alloy can have equal to or greater than 0.65 wt % Fe. In some variations, the alloy can have equal to or greater than 0.70 wt % Fe.

In some variations, the alloy can have equal to or less than 0.8 wt % Fe. In some variations, the alloy can have equal to or less than 0.7 wt % Fe. In some variations, the alloy can have equal to or less than 0.65 wt % Fe. In some variations, the alloy can have equal to or less than 0.60 wt % Fe. In some variations, the alloy can have equal to or less than 0.55 wt % Fe. In some variations, the alloy can have equal to or less than 0.50 wt % Fe. In some variations, the alloy can have equal to or less than 0.48 wt % Fe. In some variations, the alloy can have equal to or less than 0.46 wt % Fe. In some variations, the alloy can have equal to or less than 0.44 wt % Fe. In some variations, the alloy can have equal to or less than 0.42 wt % Fe.

The custom alloy is different from the commercial alloys, as most of the commercial alloys include only an upper limit for Fe.

Copper

The custom alloy may include copper, which can have impact on the mechanical strength. Cu may form a Q phase (Al—Cu—Mg—Si), which consumes Mg and Si, thus may reduce strength, because Mg and Si are not available to form MgSi strengthening particles. However, the Q phase may also provide some strengthening, which partially offsets the strength loss from consuming Mg and Si.

In some variations, the custom alloy can have Cu ranging from 0.15 wt % to 0.40 wt %.

In some variations, the alloy can have equal to or greater than 0.15 wt % Cu. In some variations, the alloy can have equal to or greater than 0.16 wt % Cu. In some variations, the alloy can have equal to or greater than 0.17 wt % Cu. In some variations, the alloy can have equal to or greater than 0.18 wt % Cu. In some variations, the alloy can have equal to or greater than 0.19 wt % Cu. In some variations, the alloy can have equal to or greater than 0.20 wt % Cu. In some variations, the alloy can have equal to or greater than 0.21 wt % Cu. In some variations, the alloy can have equal to or greater than 0.22 wt % Cu. In some variations, the alloy can have equal to or greater than 0.23 wt % Cu. In some variations, the alloy can have equal to or greater than 0.24 wt % Cu. In some variations, the alloy can have equal to or greater than 0.25 wt % Cu. In some variations, the alloy can have equal to or greater than 0.30 wt % Cu. In some variations, the alloy can have equal to or greater than 0.35 wt % Cu.

In some variations, the alloy can have equal to or less than 0.40 wt % Cu. In some variations, the alloy can have equal to or less than 0.35 wt % Cu. In some variations, the alloy can have equal to or less than 0.30 wt % Cu. In some variations, the alloy can have equal to or less than 0.25 wt % Cu. In some variations, the alloy can have equal to or less than 0.24 wt % Cu. In some variations, the alloy can have equal to or less than 0.23 wt % Cu. In some variations, the alloy can have equal to or less than 0.22 wt % Cu. In some variations, the alloy can have equal to or less than 0.21 wt % Cu. In some variations, the alloy can have equal to or less than 0.20 wt % Cu. In some variations, the alloy can have equal to or less than 0.19 wt % Cu. In some variations, the alloy can have equal to or less than 0.18 wt % Cu. In some variations, the alloy can have equal to or less than 0.17 wt % Cu. In some variations, the alloy can have equal to or less than 0.16 wt % Cu.

Manganese

The custom alloy may include manganese, because Mn is present at a high level in UBC scrap, and the range of Mn is selected to control the negative effects of high Mn. For example, Mn may form AlMn phase which can have cosmetic and corrosion impacts. Mn may also form AlFeSiMn phase, which may have cosmetic, corrosion, and strength impacts.

In some variations, the custom alloy can have Mn ranging from 0.80 wt % to 1.10 wt %.

In some variations, the alloy can have equal to or greater than 0.80 wt % Mn. In some variations, the alloy can have equal to or greater than 0.85 wt % Mn. In some variations, the alloy can have equal to or greater than 0.90 wt % Mn. In some variations, the alloy can have equal to or greater than 0.95 wt % Mn. In some variations, the alloy can have equal to or greater than 1.00 wt % Mn. In some variations, the alloy can have equal to or greater than 1.05 wt % Mn.

In some variations, the alloy can have equal to or less than 1.10 wt % Mn. In some variations, the alloy can have equal to or less than 1.05 wt % Mn. In some variations, the alloy can have equal to or less than 1.00 wt % Mn. In some variations, the alloy can have equal to or less than 0.95 wt % Mn. In some variations, the alloy can have equal to or less than 0.90 wt % Mn. In some variations, the alloy can have equal to or less than 0.85 wt % Mn.

The custom alloy is different from the commercial alloys, as most of the commercial alloys include only an upper limit for Mn.

Impurities introduced to Recycled Alloys

Elements that can impact corrosion and cosmetics may be controlled in the custom alloy. For example, some elements such as chromium (Cr), zinc (Zn), titanium (Ti), calcium (Ca), sodium (Na), gallium (Ga), tin (Sn), vanadium (V), boron (B), zirconium (Zr), lithium (Li), cadmium (Cd), lead (Pb), nickel (Ni), and phosphorus (P) among others, may be controlled to be present in low amounts to improve corrosion resistance and have good cosmetic appeal.

In some variations, the custom alloy can have up to 0.10 wt % Cr. In some variations, the alloy can have up to 0.09 wt % Cr. In some variations, the alloy can have up to 0.08 wt % Cr. In some variations, the alloy can have up to 0.07 wt % Cr. In some variations, the alloy can have up to 0.06 wt % Cr. In some variations, the alloy can have up to 0.05 wt % Cr. In some variations, the alloy can have up to 0.04 wt % Cr. In some variations, the alloy can have up to 0.03 wt % Cr.

In some variations, the alloy can have up to 0.25 wt % Zn. In some variations, the alloy can have up to 0.20 wt % Zn. In some variations, the alloy can have up to 0.15 wt % Zn. In some variations, the alloy can have up to 0.10 wt % Zn. In some variations, the alloy can have up to 0.05 wt % Zn. In some variations, the alloy can have up to 0.01 wt % Zn.

In some variations, the alloy can have up to 0.10 wt % Ti. In some variations, the alloy can have up to 0.09 wt % Ti. In some variations, the alloy can have up to 0.08 wt % Ti. In some variations, the alloy can have up to 0.07 wt % Ti. In some variations, the alloy can have up to 0.06 wt % Ti. In some variations, the alloy can have up to 0.05 wt % Ti.

In some variations, the alloy can have up to 0.050 wt % Ca. In some variations, the alloy can have up to 0.040 wt % Ca. In some variations, the alloy can have up to 0.030 wt % Ca. In some variations, the alloy can have up to 0.020 wt % Ca. In some variations, the alloy can have up to 0.010 wt % Ca. In some variations, the alloy can have up to 0.005 wt % Ca.

In some variations, the alloy can have up to 0.05 wt % Na. In some variations, the alloy can have up to 0.04 wt % Na. In some variations, the alloy can have up to 0.03 wt % Na. In some variations, the alloy can have up to 0.02 wt % Na.

In some variations, the alloy can have up to 0.20 wt % Ga. In some variations, the alloy can have up to 0.10 wt % Ga. In some variations, the alloy can have up to 0.05 wt % Ga.

In some variations, the alloy can have up to 0.20 wt % Sn. In some variations, the alloy can have up to 0.10 wt % Sn. In some variations, the alloy can have up to 0.05 wt % Sn.

In some variations, the alloy can have up to 0.20 wt % V. In some variations, the alloy can have up to 0.10 wt % V. In some variations, the alloy can have up to 0.05 wt % V.

In some variations, the alloy can have up to 0.01 wt % B.

In some variations, the alloy can have up to 0.01 wt % Zr.

In some variations, the alloy can have up to 0.01 wt % Li.

In some variations, the alloy can have up to 0.01 wt % Cd.

In some variations, the alloy can have up to 0.01 wt % Pb.

In some variations, the alloy can have up to 0.01 wt % Ni.

In some variations, the alloy can have up to 0.01 wt % P.

The alloys can be described by various wt % of elements, as well as specific properties. In all descriptions of the alloys described herein, it will be understood that the wt % balance of alloys is Al and incidental impurities. Incidental impurities can be present, for example, as a byproduct of processing and manufacturing. In various embodiments, an incidental impurity can be no greater than 0.05 wt % of any one additional element (i.e., a single impurity), and no greater than 0.10 wt % total of all additional elements (i.e., total impurities). Incidental impurities can be less than or equal to about 0.10 wt %, alternatively less than or equal about 0.05 wt %, alternatively less than or equal about 0.01 wt %, alternatively less than or equal about 0.001 wt %.

Processing

The disclosure provides a method for processing post-consumer recycled (PCR) materials into a clad and for forming cosmetic enclosures from the clad. The method increases material recycling and reduces the carbon footprint.

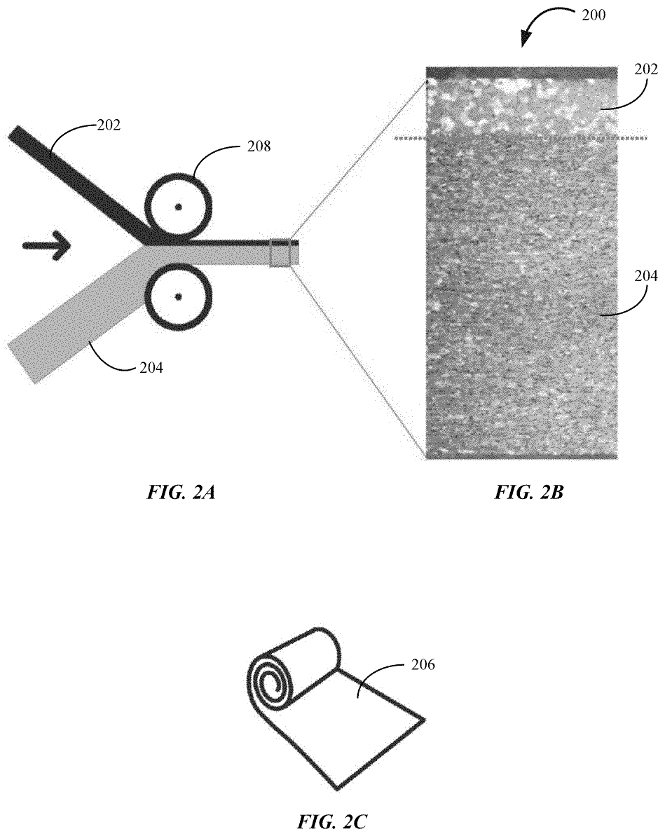

FIG. 2A illustrates hot rolling to form a clad in an embodiment of the disclosure. As shown, a surface layer 202 and a recycled substrate 204 can be rolled together through rollers 208 to form a clad 200. Rolling is a metal forming process, in which metal stock is passed through one or more pairs of rollers to reduce the thickness. Rolling is classified according to the temperature of the metal rolled. If the temperature of the metal is above its recrystallization temperature, then the process is referred to hot rolling. If the temperature of the metal is below its recrystallization temperature, the process is referred to cold rolling.

In this example, hot rolling is used to bond the surface layer 202 (e.g. cosmetic layer) to the highly recycled substrate 204 formed of the custom alloy that incorporates UBC scrap to form the clad 200.

FIG. 2B illustrates an optical image of the cross-section of FIG. 2A in an embodiment of the disclosure. As shown, the clad had a microstructure of the surface layer 202 different from the microstructure of the substrate 204 formed of the custom alloy or recycled alloy incorporating UBC scrap.

FIG. 2C illustrates a coil formed of the clad of FIG. 2A in an embodiment of the disclosure.

Scrap can have a large surface area/volume ratio compared to alloys made from virgin material. The large surface area of the scrap can include a substantial quantity of oxides, such as aluminum oxides. Scrap may also include impurities, such as Fe, Cu, among others, compared to virgin alloys of the 6000 series aluminum alloys.

The cleaning process may include removing oxides by re-melting scrap and flowing oxides and skin off the oxides. The cleaning process may also include removing organic contaminants by chemical solvent or solution.

In some embodiments, a melt for an alloy can be prepared by heating the scrap to melt the UBC. After the melt is cooled to room temperature, the alloys may go through various heat treatments, such casting, homogenization, sheet rolling, solution heat treatment, and aging, among others.

The melted scrap may be billet cast, and then homogenized. In some embodiments, the cast alloys can be homogenized by heating to an elevated temperature and holding at the elevated temperature for a period of time, such as at an elevated temperature of 520 to 620° C. for a period of time, e.g. 8-12 hours. Homogenization can be used for sheet rolling. Homogenization can reduce chemical or metallurgical segregation, which may occur as a natural result of solidification in some alloys. Homogenization can be controlled to prevent melting of the custom alloy during subsequent operations. The homogenized alloy may be sheet rolled.

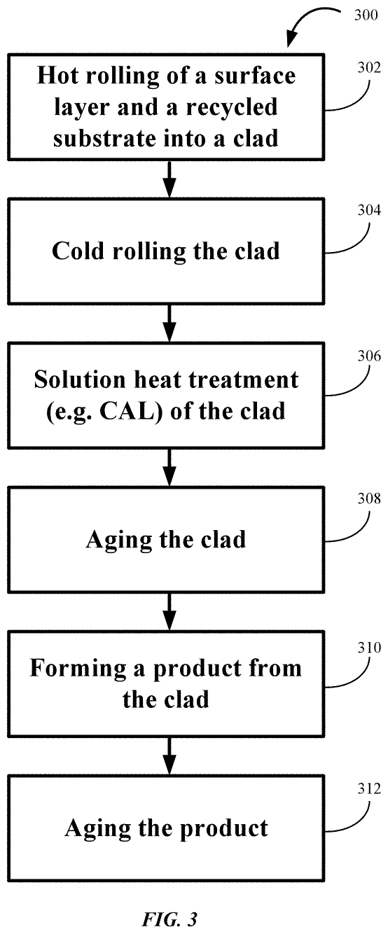

FIG. 3 illustrates a flow chart including steps for fabricating a product from a recycled material in an embodiment of the disclosure. A method 300 may include hot rolling of a surface layer (e.g. cosmetic layer) and a recycled substrate to form a clad roll at operation 302. The hot rolling may occur simultaneously at the higher elevated temperature, e.g. about 250-500° C.

The clad roll after hot rolling may be cold rolled at operation 304, followed by various heat treatments, such as solution heat treatment and aging, among others.

After cold rolling, a softened roll 206 can be formed from the clad 200 after a continuous annealing line (CAL). The CAL can be used to soften the material after cold rolling. The CAL treats a roll of aluminum alloy after cold rolling when the roll enters into a furnace, continuously moves through the furnace, and forms a softened roll after exiting the furnace. The CAL is a solution heat treatment for an aluminum alloy, including heating to an elevated temperature and holding at this temperature for a sufficient length of time to allow a desired constituent to enter into a solid solution, followed by rapid cooling to hold the constituent in the solid solution. The solution treatment intends to dissolve all the alloying elements in a solid solution.

The method 300 may also include solution heat treatment (e.g. CAL) of the clad at operation 306. The solution heat treatment can alter the strength of the alloy. The solution heat-treatment may occur at a higher elevated temperature, e.g. 500° C. or higher.

After the solution heat treatment, the clad can be aged at operation 308 at a temperature of 125-225° C. for a period of time, e.g. 6-10 hours, and then quenched with water or air. Aging is a heat treatment at an elevated temperature, and may induce a precipitation reaction to form precipitates Mg₂Si or Mg—Si. It will be appreciated by those skilled in the art that the heat treatment condition (e.g. temperature and time) may vary

The method 300 may further include forming the clad 200 into a product from the clad at operation 310. The forming may include stamping among other methods. The clad can have adequate strength and adhesion to survive the stamping without splitting the recycled substrate from the surface layer.

The alloy is heat treatable. The method 300 may also include aging the product at operation 312.

In some variations, the clad 200 is capable of solution heat-treatment and is age-hardenable.

### Example

A simulation was performed using Thermocalc and other models to evaluate the impact of composition on various properties, including yield strength, melting temperature, and thermal conductivity. Simulations were run across the full range of Si, Mg, and Cu claimed in this disclosure.

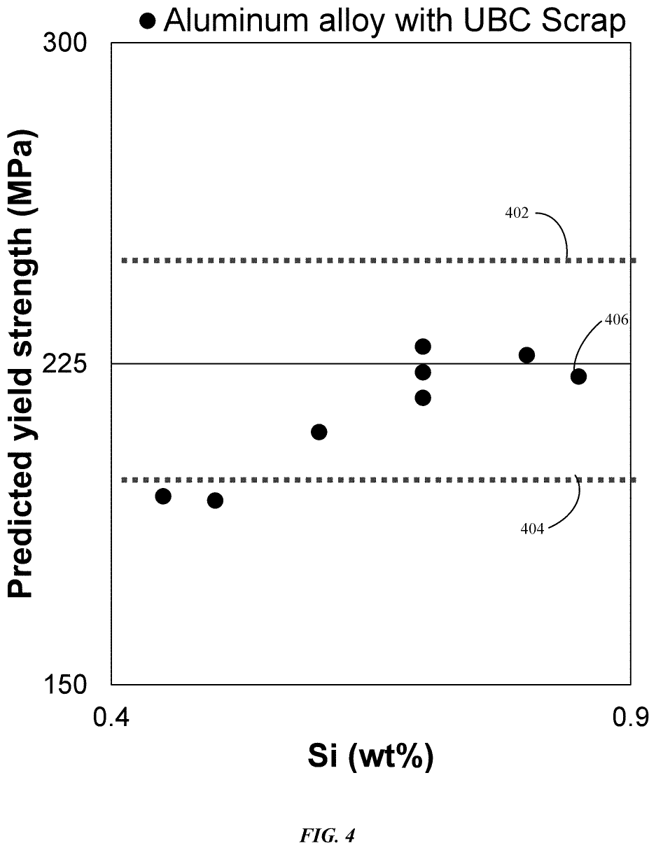

FIG. 4 illustrates estimated yield strengths versus silicon (Si) composition of a custom aluminum alloy in an embodiment of the disclosure. Dotted lines 402 and 404 represent the upper and lower limits of typical yield strengths for custom alloys, such as 6000 series aluminum alloys for cosmetic layer(s), for example, between 200 MPa and 250 MPa. Dots 406 represent the predicted yield strength for the custom alloys with the disclosed compositions. As shown in FIG. 4, the predicted yield strength for the custom alloys are mostly within the dotted lines 402 and 404, which suggests that the custom alloy has a yield strength similar to cosmetic alloys, such as 6000 series alloys for cosmetic layer(s).

The surface aluminum alloy can be a 6000 series aluminum alloy, and has a composition of 0.35 to 0.80 wt % Si, 0.45-0.95 wt % Mg, 0.10-0.50 wt % Fe, 0.005-0.009 wt % Mn, and 0.03-0.05 wt % Cu, wherein the balance is aluminum and incidental impurities. As shown by dots 406 in FIG. 4, the custom alloy had a yield strength having a trend increasing with Si content. For example, the custom alloy had a yield strength of slightly below 190 MPa at 0.5% Si, and had a yield strength of about 225 MPa at 0.7 wt % Si, which can be matched to the surface layer. The custom alloy had a yield strength of about 230 MPa at 0.8 wt % Si. It is surprising to have such a high yield strength for the custom alloy including such high amounts of elements, such as at least 0.5 wt % Fe and 0.05 wt % Cu. All of these yield strengths were from calculations.

The custom alloy can be designed to prevent melting during high temperature processing, such as homogenization, hot rolling, and CAL. The high temperature processing may be performed at the processing temperature of the surface layer. By using solidification simulations, the phases present after casting were predicted.

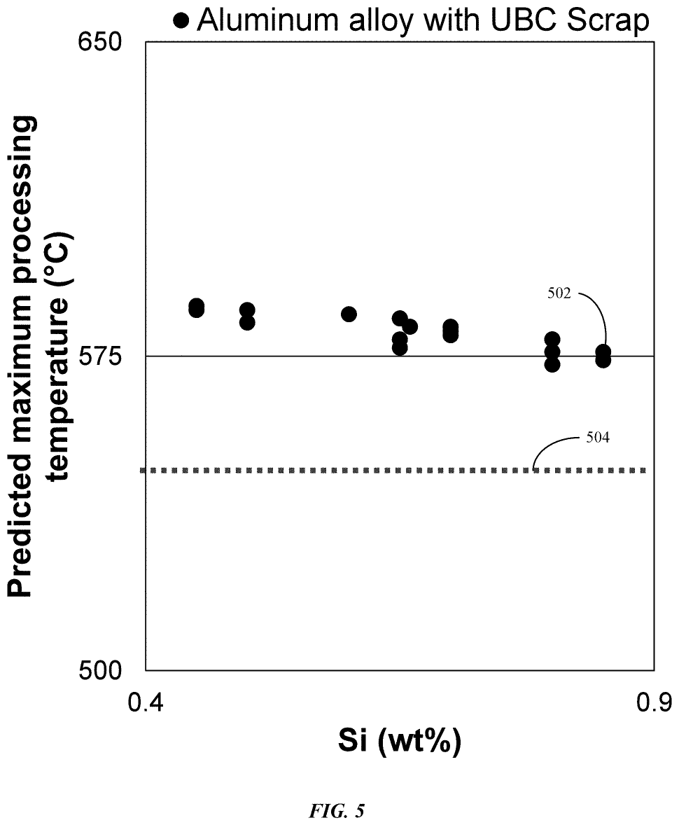

FIG. 5 illustrates the predicted maximum processing temperature versus silicon (Si) composition of a custom aluminum alloy in an embodiment of the disclosure. Dotted line 504 represents a maximum temperature of 550° C. typically encountered during production of custom alloys, such as 6000 series alloys as cosmetic layer(s). Dots 502 represent predicted maximum processing temperatures for the custom alloy having the disclosed compositions. As shown in FIG. 5, the dots 502 were all above the dotted line 504, which suggests that the custom alloy can be produced in a clad configuration with typical 6000 series aluminum alloys.

As shown by the dots 502, the predicted maximum processing temperature decreased with increasing Si content. For example, the custom alloy had a predicted maximum processing temperature above 575° C. at 0.5 wt % Si, which was above the processing temperature of 550° C. for the surface layer. The custom alloy also had a predicted maximum processing temperature of about 575° C. at 0.8 wt % Si, which was also above the processing temperature of 550° C. for the surface layer.

In order to process the custom alloy with the surface layer in the clad configuration, by hot rolling and CAL process, it was desirable for the custom alloy to have higher predicted maximum processing temperature, which can be above the processing temperature of the surface layer.

According to the results shown in FIG. 5, controlled homogenization can prevent melting of the custom alloy during CAL. The homogenization of the custom alloy can be at 520° C. for 8 hours, followed by annealing at 560° C. for 16 hours.

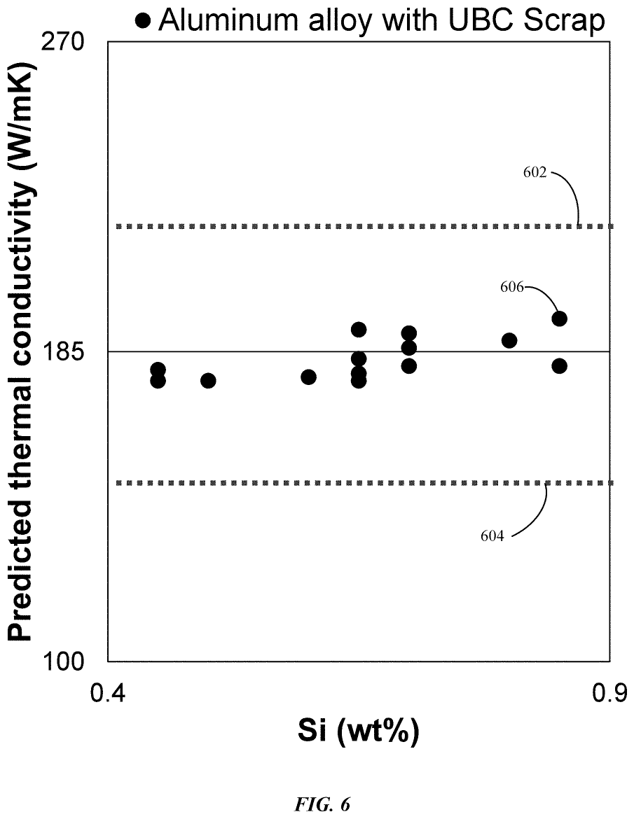

It was also desirable to increase thermal conductivity for the alloy. FIG. 6 illustrates estimated thermal conductivities versus silicon (Si) composition of a custom aluminum alloy in an embodiment of the disclosure. Dotted lines 602 and 604 represent upper and lower limits of typical thermal conductivities for custom alloys, such as 6000 series alloys for cosmetic layer(s), for example between 150 W/mK and 220 W/mK. Dots 606 represent predicted thermal conductivity for the custom alloy with disclosed compositions, which were between the dotted lines 602 and 604, as shown in FIG. 6. This suggests that the custom alloys have thermal conductivities similar to that of cosmetic 6000 series aluminum alloys for the cosmetic layer(s).

As shown by dots 606, the custom alloy had a thermal conductivity with a trend increasing with Si content. For example, the custom alloy had a thermal conductivity below 185 W/mK at 0.5 wt % Si, and had a thermal conductivity about 185 W/mK at 0.7 wt %. The custom alloy had a thermal conductivity above 185 W/mK at 0.8 wt % Si. It was surprising to have such a high thermal conductivity for the custom alloy including such high amounts of unintended elements, such as at least 0.5 wt % Fe and at least 0.05 wt % Cu.

Samples of custom alloys with the claimed compositions were prepared under various aging conditions. Aging is a heat treatment at an elevated temperature for a period of time, and may induce a precipitation reaction to form precipitates Mg₂Si or Mg—Si. The amounts of precipitates may vary with aging conditions. As such, mechanical properties may vary with the aging conditions for the same alloy composition.

In some variations, aging temperatures may range from 160° C. to 200° C. In some variations, the aging temperature is equal to or greater than 160° C. In some variations, the aging temperature is equal to or greater than 165° C. In some variations, the aging temperature is equal to or greater than 170° C. In some variations, the aging temperature is equal to or greater than 175° C. In some variations, the aging temperature is equal to or greater than 180° C. In some variations, the aging temperature is equal to or greater than 185° C. In some variations, the aging temperature is equal to or greater than 190° C. In some variations, the aging temperature is equal to or greater than 195° C.

In some variations, the aging temperature is equal to or less than 165° C. In some variations, the aging temperature is equal to or less than 170° C. In some variations, the aging temperature is equal to or less than 175° C. In some variations, the aging temperature is equal to or less than 180° C. In some variations, the aging temperature is equal to or less than 185° C. In some variations, the aging temperature is equal to or less than 190° C. In some variations, the aging temperature is equal to or less than 195° C. In some variations, the aging temperature is equal to or less than 200° C.

In some variations, aging times may range from 2 hours to 24 hours. In some variations, the aging time is equal to or greater than 2 hours. In some variations, the aging time is equal to or greater than 4 hours. In some variations, the aging time is equal to or greater than 6 hours. In some variations, the aging time is equal to or greater than 8 hours. In some variations, the aging time is equal to or greater than 10 hours. In some variations, the aging time is equal to or greater than 12 hours. In some variations, the aging time is equal to or greater than 14 hours. In some variations, the aging time is equal to or greater than 16 hours. In some variations, the aging time is equal to or greater than 18 hours. In some variations, the aging time is equal to or greater than 20 hours. In some variations, the aging time is equal to or greater than 22 hours.

In some variations, the aging time is equal to or less than 4 hours. In some variations, the aging time is equal to or less than 6 hours. In some variations, the aging time is equal to or less than 8 hours. In some variations, the aging time is equal to or less than 10 hours. In some variations, the aging time is equal to or less than 12 hours. In some variations, the aging time is equal to or less than 14 hours. In some variations, the aging time is equal to or less than 16 hours. In some variations, the aging time is equal to or less than 18 hours. In some variations, the aging time is equal to or less than 20 hours. In some variations, the aging time is equal to or less than 22 hours. In some variations, the aging time is equal to or less than 24 hours.

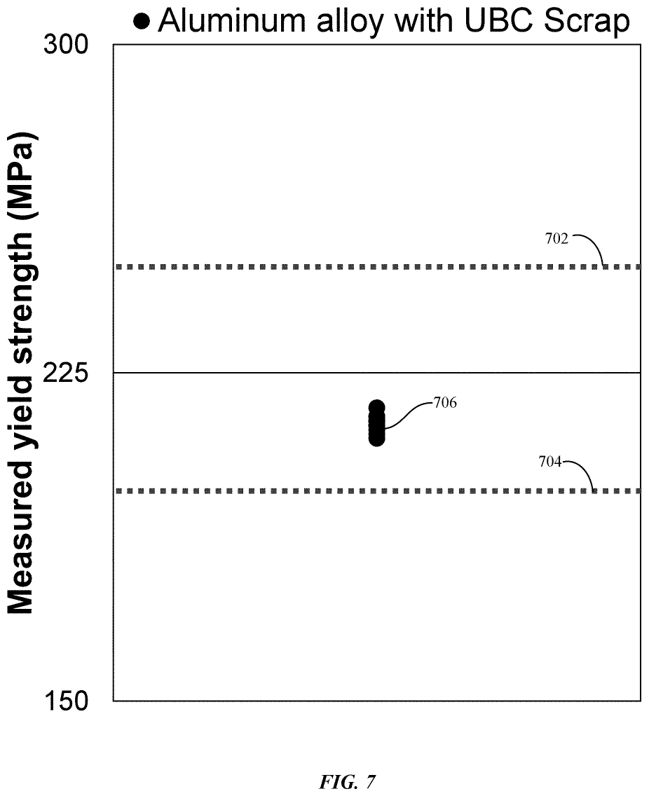

FIG. 7 illustrates measured yield strengths of custom aluminum alloys in an embodiment of the disclosure. As shown in FIG. 7, dots 706 represent the measured yield strengths for the custom alloys with the claimed compositions under various aging conditions. The yield strengths are within the upper value of 250 MPa on dotted line 702 and lower value of 200 MPa on dotted line 704 of typical cosmetic 6xxx series alloys.

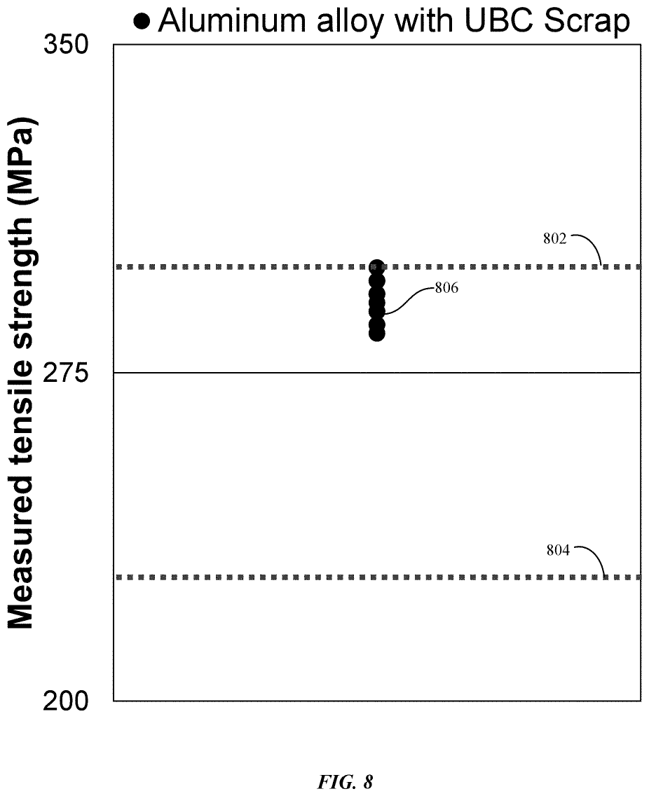

FIG. 8 illustrates measured tensile strengths of custom aluminum alloys in an embodiment of the disclosure. As shown in FIG. 8, dots 806 represent the measured tensile strengths for the custom alloys with the claimed compositions under various aging conditions. The yield strengths are within the upper value of 300 MPa on dotted line 802 and lower value of 230 MPa on dotted line 804 of typical cosmetic 6xxx series alloys. The measurements show that the custom alloys have similar yield strengths and tensile strength to the cosmetic 6xxx alloys.

Note that the measured yield strengths in FIG. 7 fell within the predicted yield strengths as shown in FIG. 4.

Used Beverage Can (UBC) Scrap Compositions

Beverage cans are made from 3000 and 5000 series aluminum alloys (e.g. 3104 aluminum sheet). The 3104 aluminum sheet has good deep-drawing property, which is suitable for thinning the tensile lightweight materials to reduce the quantity of material. The process for fabricating the can included hot-rolling, cold-rolling, and finishing. Typical beverage can alloys are not heat-treatable.

Alloy compositions were collected for UBC. Due to low material cost and contamination from the recycling process, the UBCs were generally very “dirty” and included many undesirable elements. For example, the UBCs included large amounts of Fe and Cu unsuitable for cosmetic and material purposes. The composition data for each of elements Si, Mg, Fe, Mn, Cu, Zn, Ti, and Cr in the UBCs were provided below.

UBC scrap included a mixture of 3000 and 5000 series aluminum alloys, with large amounts of alloying elements Mg, Mn, and Cu, and undesirable elements Fe, Zn, Ti, Cr, and others. This makes UBC scrap unsuitable for use in typical heat-treatable and cosmetic aluminum alloys.

UBC scrap may include Mg of about 1.2 wt %, Si of about 0.3 wt %, Mn of about 0.8 wt %, Fe of about 0.4 wt %, and Cu of about 0.2 wt %. UBC scrap composition may vary significantly by market and scrap source.

In some variations, UBC scrap may include Mg of 0.8-1.3, Si of 0-0.6, Cu of 0.05-0.25, Mn of 0.8-1.4, Fe of 0-0.8 for the 3000 series aluminum alloy and Mg of 4.0-5.0, Si of 0-0.2, Cu of 0-0.15, Mn of 0.2-0.5, and Fe of 0-0.35 for the 5000 series aluminum alloy. In some variations, the custom alloy can incorporate the UBC and add more Si, Mg, among others.

In some variations, the custom alloy can accommodate UBC scrap up to 100%.

In some variations, the custom alloy can accommodate UBC scrap greater than 80.0%. In some variations, the custom alloy can accommodate UBC scrap greater than 85.0%. In some variations, the custom alloy can accommodate UBC scrap greater than 90.0%. In some variations, the custom alloy can accommodate UBC scrap greater than 95%. In some variations, the custom alloy can accommodate UBC scrap greater than 99.0%. In some variations, the custom alloy can accommodate UBC scrap greater than 99.5%. In some variations, the custom alloy can accommodate UBC scrap greater than 99.8%.

The disclosed alloys and methods can be used in the fabrication of electronic devices. An electronic device herein can refer to any electronic device known in the art. For example, such devices can include wearable devices such as a watch (e.g., an AppleWatch®). Devices can also be a telephone such a mobile phone (e.g., an iPhone®) a land-line phone, or any communication device (e.g., an electronic email sending/receiving device). The alloys can be a part of a display, such as a digital display, a TV monitor, an electronic-book reader, a portable web-browser (e.g., iPad®), and a computer monitor. The alloys can also be an entertainment device, including a portable DVD player, conventional DVD player, Blue-Ray disk player, video game console, music player, such as a portable music player (e.g., iPod®), etc. The alloys can also be a part of a device that provides control, such as controlling the streaming of images, videos, sounds (e.g., Apple TV®), or can be a remote control for an electronic device. The alloys can be a part of a computer or its accessories, such as the hard drive tower housing or casing for iMac or MacBook.

Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall therebetween.

What is claimed is:

1. An aluminum alloy comprising:
0.45 to 0.85 wt % Si;
0.15 to 0.40 wt % Cu;
0.40 to 0.80 wt % Fe;
1.20 to 1.65 wt % Mg; and
0.8 to 1.1 wt % Mn,
wherein the balance is aluminum and incidental impurities.

2. The alloy of claim 1, further comprising:
up to 0.25 wt % Zn;
up to 0.10 wt % Cr;
up to 0.10 wt % Ti;
up to 0.05 wt % Ca;
up to 0.05 wt % Na;
0 to 0.20 wt % Ga;
0 to 0.20 wt % Sn;
0 to 0.20 wt % V;
0 to 0.01 wt % B;
0 to 0.01 wt % Zr;
0 to 0.01 wt % Li;
0 to 0.01 wt % Cd;
0 to 0.01 wt % Pb;
0 to 0.01 wt % Ni;
0 to 0.01 wt % P;
and combinations thereof.

3. The alloy of claim 1, wherein the alloy has a yield strength after aging of at least 170 MPa.

4. The alloy of claim 1, wherein the alloy has a thermal conductivity after aging of at least 150 W/mk.

5. The alloy of claim 1, wherein the alloy can be processed at temperatures of at least 550° C. without melting

6. The alloy of claim 1, wherein the alloy comprises at least 90% of used beverage can (UBC) scrap.

7. A clad comprising:
a substrate formed of the aluminum alloy of claim 1; and
a first surface layer disposed on a first surface of the substrate, the surface layer formed of an aluminum alloy having a different chemical composition than the substrate.

8. The clad of claim 7, wherein the substrate comprises at least 90% of UBC scrap.

9. The clad of claim 7, wherein the first surface layer has a composition of 0.35 to 0.80 wt % Si, 0.45-0.95 wt % Mg, 0.10-0.50 wt % Fe, 0.005-0.009 wt % Mn, and 0.03-0.05 wt % Cu, wherein the balance is aluminum and incidental impurities.

10. The clad of claim 7, wherein the surface layer has a yield strength of at least 205 MPa.

11. The clad of claim 7, wherein the surface layer has a thermal conductivity of at least 150 W/mk.

12. The clad of claim 7, wherein the clad further comprises a second surface layer disposed on a surface of the substrate opposing the first surface layer such that the substrate is between the first surface layer and the second surface layer.

13. The clad of claim 7, wherein the clad is capable of solution heat-treatment.

14. The clad of claim 7, wherein the clad is age-hardenable.

15. A method of fabricating a product from the clad of claim 7, the method comprising:
hot rolling the first surface layer and the substrate to form a clad;
cold rolling the clad to form a rolled clad;
solution heat treating the rolled clad to form a heat treated clad; and
forming a product from the heat treated clad.

16. The method of claim 15, the step of solution heat treating the rolled clad comprising continuously annealing the rolled clad.

17. The method of any one of claim 15, the step of forming a product from the heat treated clad comprising stamping the heat treated clad to form a product.

18. The method of claim 17, wherein the product comprises an electronic housing.

19. The method of claim 15, wherein the substrate comprises at least 90% of UBC scrap.

20. The method of claim 15, further comprising aging the clad and/or aging the product.
